(19) United States
(12) Patent Application Publication
(10) Pub. No.: US 2022/0340752 A1
(43) Pub. Date: Oct. 27, 2022

(54) THERMOPLASTIC MOLDING COMPOSITION

(71) Applicant: BASF SE, Ludwigshafen am Rhein (DE)

(72) Inventors: Jens Cremer, Ludwigshafen (DE); Andre Schaefer, Ludwigshafen (DE); Tsung-Chie Cheng, Ludwigshafen (DE); Boris Weber, Ludwigshafen (DE)

(21) Appl. No.: 17/619,758

(22) PCT Filed: Jun. 23, 2020
(86) PCT No.: PCT/EP2020/067420

§ 371 Date: Dec. 16, 2021

(30) Foreign Application Priority Data
Jun. 24, 2019 (EP) 19182014.1

(51) Int. Cl. C08L 77/02; C08G 69/28

(52) U.S. Cl. CPC C08L 77/02; C08G 69/28

(57) ABSTRACT

Described herein is a thermoplastic molding composition, including
A) from 10 to 60% by weight of a thermoplastic semicrystalline polyamide-6,
B) from 5 to 50% by weight of a thermoplastic semiaromatic semicrystalline polyamide containing repeating units of hexamethylenediamine and terephthalic acid,
C) from 10 to 65% by weight of fibrous and/or particulate fillers, and
D) from 0 to 30% by weight of further additives,

where the total of the percentages by weight of components A) to D) is 100%.

### DESCRIPTION

The present invention relates to a thermoplastic molding composition comprising polyamide-6 and a semiaromatic polyamide which can be used for preparing fibers, foils or moldings.

Thermoplastic polyamides, such as polyamide-6 and polyamide-66, are often used in the form of glass fiber-reinforced molding compositions with a good processability, good mechanical properties and good resistance against numerous chemicals. Due to the water intake these polyamide compounds have significantly reduced mechanical parameters in humid environments compared to dry air conditions.

By including an amorphous semiaromatic polyamide-6I/6T in polyamide-66 glass fiber reinforced polyamide compounds can be obtained which have improved mechanical properties in humid environments at temperatures of up to 60° C., compared to glass fiber-reinforced polyamide-6 or polyamide-66 without additives.

EP 0 400 428 A1 discloses thermoplastic molding compositions comprising polyamide-6T/6 or polyamide-66 to which polyamide-6I/6T is added for improving the mechanical properties.

EP 0 728 812 A1 discloses thermoplastic molding compositions based on polyamide-6T/6 or polyamide-6T/6I to which a copolyamide-6I/6T is added for improving the mechanical properties.

A disadvantage of polyamide-66/polyamide-6I/6T blends is the high melting point of 260° C., which is near the melting point of pure polyamide-66. Furthermore, the blends have a small temperature window for their application, since above 60° C. the materials, due to the amorphous polyamide content, show only weak mechanical properties.

The object underlying the present invention is to provide fiber or particulate-reinforced polyamide compositions which overcome the disadvantages of the known molding compositions, specifically the high melting point and the significant decrease in mechanical properties at elevated temperatures.

The object is achieved according to the present invention by a thermoplastic molding composition, comprising
A) from 10 to 60% by weight of a thermoplastic semicrystalline polyamide-6,
B) from 5 to 50% by weight of a thermoplastic semiaromatic semicrystalline polyamide containing repeating units of hexamethylenediamine and terephthalic acid,
C) from 10 to 65% by weight of fibrous and/or particulate fillers,
D) from 0 to 30% by weight of further additives, where the total of the percentages by weight of components A) to D) is 100%.

The invention also relates to the use of a thermoplastic semiaromatic semicrystalline polyamide containing repeating units of hexamethylenediamine and terephthalic acid as an additive for thermoplastic semicrystalline polyamide-6 compositions for improving the mechanical properties at temperatures above 60° C. and in humid environments.

The invention also relates to the use of these thermoplastic molding compositions for producing fibers, foils, and moldings of any type.

The invention furthermore relates to a fiber, foil or molding, made of these thermoplastic molding compositions.

According to the present invention, it has been found that a combination of thermoplastic semicrystalline polyamide-6 and a thermoplastic semiaromatic semicrystalline polyamide, containing repeating units of hexamethylenediamine and terephthalic acid as well as a fibrous or particulate filler, achieves the above mentioned object.

The amount of component A) is 10 to 60% by weight, preferably 15 to 50% by weight, more preferably 25 to 45% by weight.

The amount of component B) is 5 to 50% by weight, preferably 5 to 40% by weight, more preferably 10 to 25% by weight.

Preferably, the weight ratio of component A) to component B) is at least 1:1, more preferably at least 1.1:1, most preferably at least 1.5:1. Preferably, the weight ratio of component A) to component B) is 1:1 to 10:1, more preferably 1.1:1 to 7:1, most preferably 1.5:1 to 5:1, specifically 2:1 to 4:1.

The amount of component C) is from 10 to 65% by weight, preferably 30 to 65% by weight, more preferably 40 to 60% by weight.

The amount of component D) is from 0 to 30% by weight, preferably 0 to 20% by weight, more preferably 0 to 10% by weight. If present, the amount of component D) is 0.1 to 30% by weight, preferably 0.5 to 20% by weight, more preferably 1 to 10% by weight.

Component A) is a thermoplastic semicrystalline polyamide-6.

Component A) preferably has a viscosity number VZ of 10.0 to 250 ml/g, more preferably 120 to 190 ml/g, measured on a 0.5% strength by weight solution in 96% strength by weight of sulfuric acid at 25° C. to ISO 307.

The polyamide-6 can contain minor amounts of hexamethylene adipamide units of up to 10% by weight, more preferably of up to 5% by weight, most preferably of up to 2% by weight. In this case, a polyamide-6/66 copolyamide is employed. Preferably, no such units are present.

Component B) is a thermoplastic semiaromatic semicrystalline polyamide containing repeating units of hexamethylenediamine and terephthalic acid. Preferably, component B) contains 45 to 95% by weight, more preferably 60 to 80% by weight, most preferably 65 to 75% by weight of repeating units of hexamethylenediamine and terephthalic acid. The remainder can be aliphatic polyamide repeating units, like caprolactam or hexamethylene adipamide, or semiaromatic repeating units, like polyamide-6I.

Preferably, the thermoplastic semiaromatic semicrystalline polyamide B) is selected from polyamide-6T/6, polyamide-6T/66, polyamide-6T/6I and mixtures thereof.

Preferably, component B) has a viscosity number VZ of 60 to 200 ml/g, more preferably 70 to 140 ml/g.

Fibrous or particulate fillers C) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar.

Preferred fibrous fillers that may be mentioned are carbon fibers, aramid fibers, and potassium titanate fibers, particular preference being given to glass fibers in the form of E glass. These can be used as rovings or in the commercially available forms of chopped glass.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₄₋ₖ

where the definitions of the substituents are as follows:

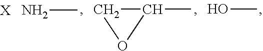

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on C1)).

Acicular mineral fillers are also suitable. For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The thermoplastic molding compositions of the invention can comprise, as component D), conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, etc.

Examples of suitable components D) are exemplified in the following as components D1) to D4).

The molding compositions of the invention can comprise, as component D1), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component D2), from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably KI, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising the polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6.

Examples of oxidation retarders/antioxidants and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 3% by weight, more preferably up to 1,5% by weight, most preferably up to 1% by weight, based on the weight of the thermoplastic molding compositions.

Suitable sterically hindered phenols D3) are in principle all of the compounds which have a phenolic structure and which have at least one bulky group on the phenolic ring.

It is preferable to use, for example, compounds of the formula

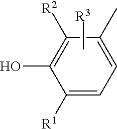

where:

R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is provided by those derived from substituted benzenecarboxylic acids, in particular from substituted benzenepropionic acids.

Particularly preferred compounds from this class are compounds of the formula

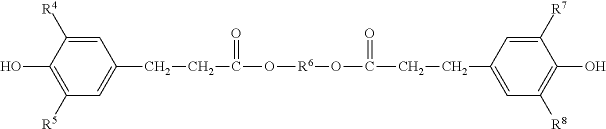

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

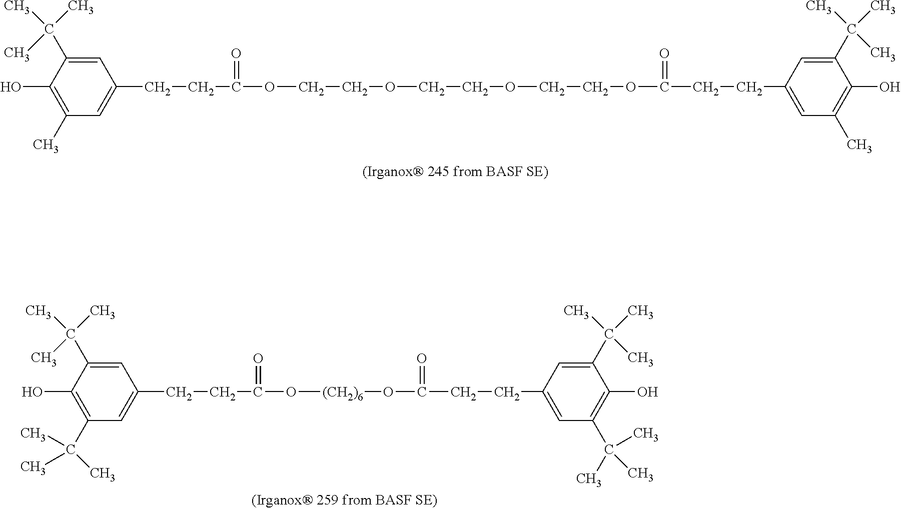

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)-benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from BASF SE, which has particularly good suitability.

The amount comprised of the antioxidants D), which can be used individually or as a mixture, is from 0.05 up to 3% by weight, preferably from 0.1 to 1.5% by weight, in particular from 0.1 to 1% by weight, based on the total weight of the molding compositions A) to D).

In some instances, sterically hindered phenols having not more than one sterically hindered group in ortho-position with respect to the phenolic hydroxy group have proven particularly advantageous; in particular when assessing colorfastness on storage in diffuse light over prolonged periods.

Examples of other conventional additives D4) are amounts of up to 25% by weight, preferably up to 20% by weight, of elastomeric polymers (also often termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricycledienes, such as 3-methyltricyclo[5.2.1.0^{2.6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These dicarboxylic acid derivatives or monomers comprising epoxy groups are preferably incorporated into the rubber by adding to the monomer mixture monomers comprising dicarboxylic acid groups and/or epoxy groups and having the general formulae I or II or III or IV

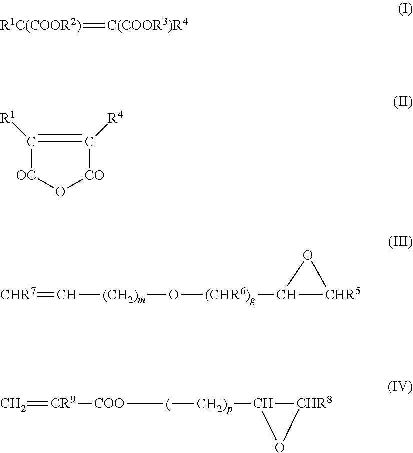

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as, for example, n-butyl acrylate and 2-ethylhexyl acrylate, corresponding methacrylates, butadiene and isoprene, and also mixtures of these. These monomers may be copolymerized with other monomers, such as, for example, styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

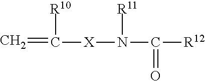

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise O or by groups that comprise N,
X is a chemical bond, a C₁-C₁₀-alkylene group, or a C₆-C₁₂-arylene group, or

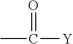

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, |
| | n-butyl acrylate, ethylhexyl | methyl methacrylate |
| | acrylate, or a mixture of these | |
| II | as I, but with concomitant | as I |
| | use of cross-linking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, | first envelope composed of |
| | methyl methacrylate, or | monomers as described under |
| | a mixture of these | I and II for the core, second |
| | | envelope as described under I |
| | | or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

Materials that can be used as nucleating agents are sodium phenylphosphinate, aluminum oxide, silicon dioxide, and also preferably talc.

The thermoplastic molding compositions of the invention can be produced by processes known per se, by mixing the starting components in conventional mixing apparatus, such as screw-based extruders, Brabender mixers, or Banbury mixers, and then extruding the same. After extrusion, the extrudate can be cooled and pelletized. It is also possible to premix individual components and then to add the remaining starting materials individually and/or likewise in the form of a mixture. The mixing temperatures are generally from 230 to 320° C.

In another preferred mode of operation, component C) can also optionally be mixed with a prepolymer of compound A), compounded, and pelletized. The pellets obtained are then solid-phase condensed under an inert gas continuously or batchwise at a temperature below the melting point of component A) until the desired viscosity has been reached.

The thermoplastic molding compositions of the invention feature good mechanical properties, even at high temperatures and humidities, and lowered melting points.

These materials are suitable for the production of fibers, foils, and moldings of any type. Some examples follow: cylinder head covers, motorcycle covers, intake manifolds, charge-air-cooler caps, plug connectors, gearwheels, cooling-fan wheels, and cooling-water tanks.

In the electrical and electronic sector, improved-flow polyamides can be used to produce plugs, plug parts, plug connectors, membrane switches, printed circuit board modules, microelectronic components, coils, I/O plug connectors, plugs for printed circuit boards (PCBs), plugs for flexible printed circuits (FPCs), plugs for flexible integrated circuits (FFCs), high-speed plug connections, terminal strips, connector plugs, device connectors, cable-harness components, circuit mounts, circuit-mount components, three-dimensionally injection-molded circuit mounts, electrical connection elements, and mechatronic components.

Possible uses in automobile interiors are for dashboards, steering-column switches, seat components, headrests, center consoles, gearbox components, and door modules, and possible uses in automobile exteriors are for door handles, exterior-mirror components, windshield-wiper components, windshield-wiper protective housings, grilles, roof rails, sunroof frames, engine covers, cylinder-head covers, intake pipes (in particular intake manifolds), windshield wipers, and also external bodywork components.

Possible uses of improved-flow polyamides in the kitchen and household sector are for the production of components for kitchen devices, e.g. fryers, smoothing irons, knobs, and also applications in the garden and leisure sector, e.g. components for irrigation systems, or garden devices, and door handles.

### EXAMPLES

The following components were used:

Component A)

PA6:

Polyamide-6 having a viscosity number VZ of 150 ml/g, measured on a 0.5 strength by weight solution in 96% strength by weight of sulfuric acid at 25° C. to ISO 307 (using Ultramid® B27 from BASF SE)

PA66:

Polyamide-66 having a viscosity number VZ of 150 ml/g, measured on a 0.5 strength by weight solution in 96% strength by weight of sulfuric acid at 25° C. to ISO 307 (using Ultramid® A27 from BASF SE).

Component B)

PA6T/6:

Polyamide-6T/6 (70:30) having a viscosity number VZ of 125 ml/g, measured on a 0.5 measured on a 0.5 strength by weight solution in 96% strength by weight of sulfuric acid at 25° C. to ISO 307 (using Ultramid® T315 from BASF SE).

PA6I/6T:

Polyamide-6I/6T (70:30) having a viscosity number VZ of 80 ml/g, measured on a 0.5 measured on a 0.5 strength by weight solution in 96% strength by weight of sulfuric acid at 25° C. to ISO 307 (using Selar® 3426 from DuPont de Nemours Deutschland GmbH).

PA6T/6I:

Polyamie-6T/6I (70:30) having a viscosity number VZ of 90 ml/g, measured on a 0.5 measured on a 0.5 strength by weight solution in 96% strength by weight of sulfuric acid at 25° C. to ISO 307 (using Arlen® 3000 from Mitsui Chemicals, Inc.).

PA6T/66:

Polyamide-6T/66 (70:30) having a viscosity number VZ of 100 ml/g, measured on a 0.5 measured on a 0.5 strength by weight solution in 96% strength by weight of sulfuric acid at 25° C. to ISO 307 (using Arlen® C2000 from Mitsui Chemicals, Inc.).

Component C)

Glass fiber:

DS 1110 having a diameter of 10 μm (from 3B Fibreglass).

Component D)

Heat stabilizer:

Irganox® 1098 from BASF SE.

Lubricant:

Ethylene bis stearamide (EBS) from Lonza Cologne GmbH.

Preparation of the granules

The nature-colored polyamide granules were dried in a drying oven at 100° C. for 4 hours so that the humidity was below 0.1%. Afterwards, they were mixed with the other components in a twin-screw extruder having a diameter of 25 mm, and a L/D ratio of 44 which was operated at 300 to 390 min-1 and at 20 kg/h and at a cylinder temperature of 290° C. for Comparative Examples 1 and 2, at 320° C. for Comparative Example 3, and at 350° C. for Examples 1 to 3. The extrudates were cooled in a water bath and subsequently granulated.

The granules obtained were used for injection-molding tensile bars, according to ISO 527-2 and Charpy sticks according to ISO 179-1. The results are shown in the below table.

Tensile modulus of elasticity, tensile stress at break and tensile strain at break are determined according to ISO 527. The values at 80° C. are obtained according to ISO 178. The Charpy (notched) impact resistance is determined according to ISO 179-2/1eU and ISO 179-2/1eAf, respectively. Melting point and crystallization temperature are determined according to ISO 11357. All of the norms refer to the version valid in 2019.

| | Comparative | Comparative | Comparative | | | |
|---|---|---|---|---|---|---|
| Composition [wt %] | Example 1 | Example 2 | Example 3 | Example 1 | Example 2 | Example 3 |
| PA 66 | 0 | 0 | 34.6 | 0 | 0 | 0 |
| PA 6 | 49.5 | 34.6 | 0 | 34.6 | 34.6 | 34.6 |
| PA 6I/6T | 0 | 14.9 | 14.9 | 0 | 0 | 0 |
| PA 6T/6 | 0 | 0 | 0 | 14.9 | 0 | 0 |
| PA 6T/6I | 0 | 0 | 0 | 0 | 14.9 | 0 |
| PA 6T/66 | 0 | 0 | 0 | 0 | 0 | 14.9 |
| Glas fiber (DS1110) | 50 | 50 | 50 | 50 | 50 | 50 |
| Heat stabilizer (Irganox ® 1098) | 0.25 | 0.25 | 0.25 | 0.25 | 0.25 | 0.25 |
| Lubricant (EBS) | 0.25 | 0.25 | 0.25 | 0.25 | 0.25 | 0.25 |

Characteristics

| | | | | | | |
|---|---|---|---|---|---|---|
| Melting point (DSC) [° C.] | 220 | 215 | 250 | 212 | 211 | 210 |
| Crystallization temperature (DSC) [° C.] | 190 | 182 | 214 | 175 | 173 | 200 |

Mechanical properties (dry)

| | | | | | | |
|---|---|---|---|---|---|---|
| Tensile modulus of elasticity [MPa] | 16056 | 16913 | 16071 | 17258 | 18660 | 18011 |
| Tensile stress at break [MPa] | 224.0 | 233 | 229 | 232 | 280 | 248 |
| Tensile strain at break [%] | 3.5 | 3.4 | 2.9 | 3.5 | 2.9 | 3.0 |
| Tensile modulus of elasticity at 80° C. [MPa] | 9659 | 7510 | 9019 | 8886 | 10404 | 9016 |
| Tensile stress at break at 80° C. [MPa] | 136.0 | 120 | 132 | 145 | 155 | 149 |
| Tensile strain at break at 80° C. [%] | 7.8 | 10.8 | 7.8 | 8.2 | 7.0 | 7.5 |
| Charpy impact resistance [kJ/m²] | 101 | 100 | 95.0 | 102 | 115 | 108 |
| Charpy notched impact resistance [kJ/m²] | 19.1 | 14.9 | 13.2 | 16.4 | 16.5 | 15.9 |

Mechanical properties (humid)

| | | | | | | |
|---|---|---|---|---|---|---|
| Tensile modulus of elasticity [MPa] | 15560 | 11984 | 15543 | 13986 | 14885 | 13359 |
| Tensile stress at break [MPa] | 165 | 145 | 194 | 183 | 198 | 185 |
| Tensile strain at break [%] | 6.5 | 5.1 | 3.7 | 5.0 | 4.2 | 4.6 |
| Tensile modulus of elasticity at 80° C. [MPa] | 5831 | 6041 | 5549 | 6855 | 8969 | 7967 |
| Tensile stress at break at 80° C. [MPa] | 106 | 79 | 87 | 91 | 118 | 106 |
| Tensile strain at break at 80° C. [%] | 6.6 | 11.2 | 11.5 | 10.2 | 7.2 | 7.7 |
| Charpy impact resistance [kJ/m²] | 110 | 76 | 104.0 | 98 | 106 | 96.0 |
| Charpy notched impact resistance [kJ/m²] | 28.3 | 15.6 | 15.0 | 17.7 | 17.3 | 20.0 |

1. A thermoplastic molding composition, comprising
A) from 10 to 60% by weight of a thermoplastic semicrystalline polyamide-6,
B) from 5 to 50% by weight of a thermoplastic semiaromatic semicrystalline polyamide containing repeating units of hexamethylenediamine and terephthalic acid,
C) from 10 to 65% by weight of fibrous and/or particulate fillers, and
D) from 0 to 30% by weight of further additives,
wherein the total of the percentages by weight of components A) to D) is 100%,
wherein the weight ratio of component A) to component B) is 1:1 to 10:1.

2. The thermoplastic molding composition according to claim 1, comprising from 30 to 65% by weight of a fibrous filler.

3. The thermoplastic molding composition according to claim 1, in which the thermoplastic polymer B) contains 55 to 95% by weight of repeating units of hexamethylenediamine and terephthalic acid.

4. The thermoplastic molding composition according to claim 1, in which the thermoplastic polymer B) is selected from the group consisting of polyamide-6T/6, polyamide-6T/66, polyamide-6T/6I, and mixtures thereof.

5. The thermoplastic molding composition according to claim 1, containing 0.05 to 3% by weight of an antioxidant as component D) or part of component D), based on the total of the percentages by weight of components A) to D) which is 100 percent.

6. The thermoplastic molding composition according to claim 1, containing 15 to 50% by weight of component A).

7. (canceled)

8. A method of using a thermoplastic semiaromatic semicrystalline polyamide containing repeating units of hexamethylenediamine and terephthalic acid, the method comprising using the thermoplastic semiaromatic semicrystalline polyamide containing repeating units of hexamethylenediamine and terephthalic acid as an additive for thermoplastic semicrystalline polyamide-6 compositions for improving the mechanical properties at temperatures above 60° C. and in humid environments, wherein the weight ratio of the thermoplastic semicrystalline polyamide-6 compositions to the thermoplastic semiaromatic semicrystalline polyamide containing repeating units of hexamethylenediamine and terephthalic acid is 1:1 to 10:1.

9. The method according to claim 8, the method comprising using the thermoplastic semiaromatic semicrystalline polyamide containing repeating units of hexamethylenediamine and terephthalic acid as an additive for producing fibers, foils, and moldings of any type.

10. A fiber, foil or molding, made of the thermoplastic molding composition according to 6 claim 1.
